(19) United States
(12) Patent Application Publication
(10) Pub. No.: US 2010/0162597 A1
(43) Pub. Date: Jul. 1, 2010

(54) IDENTIFICATION MODULE FOR FACILITATING INSTALLATION OF FUNCTIONAL COMPONENT

(75) Inventors: TZU-WEI TAI, Taipei City (TW); Ya-Chyi Chou, Taipei City (TW); Hsing-Cheng Liu, Taipei City (TW); Yen-Ting Liu, Taipei City (TW); Po-Yang Shih, Taipei City (TW); Cheng-Han Chang, Taipei City (TW); Ting-Kuo Kao, Taipei City (TW)

Correspondence Address: MICHAEL W. TAYLOR, P.O. BOX 3791, ORLANDO, FL, 32802-3791, US

(73) Assignee: ASUSTeK Computer Inc., Taipei City (TW)

(21) Appl. No.: 12/644,491

(22) Filed: Dec. 22, 2009

(30) Foreign Application Priority Data
Dec. 29, 2008 (TW) 097151301

(51) Int. Cl. G09F 3/00

(52) U.S. Cl. 40/299.01

(57) ABSTRACT

An identification module for facilitating installation of a functional component includes a circuit board having a first connecting portion, a first functional component, a first primary label disposed on the first connecting portion and a first subsidiary label disposed on the first functional component, wherein the first subsidiary label and the first primary label respectively have two first identifying symbols corresponding to each other. With intuitional identify the first identifying symbols, a correlation between the first functional component and the first connecting portion is easily cognized, therefore facilitates installation and increase efficiency and yield thereof.

### FIELD OF THE INVENTION

The present invention relates to an identification module, particularly to an identification module for facilitating installation of a functional component.

### BACKGROUND OF THE INVENTION

The present invention relates to an identification module, particularly to an identification module for facilitating installation of a functional component.

With highly development of technology, electronic products provides more and more marvelous performance and functions. With such, the electronic products inevitably become more and more complex and assembly or installation process of the electronic products get more and more difficult as well. For instance, present computers with high performance mostly have plenty of various electronic components for installing on motherboards thereof. Due to the difficulty of cognizing correlation between the various electronic components and corresponding connectors or sockets, installation, assembly or replacing those electronic components may become a very tedious and mistakable task.

Once the electronic components are mounted in wrong sockets or connectors, the electronic components or other relevant electronic components may be damaged or broken.

Furthermore, when the electronic components mounted in wrong sockets or connectors, users have to perform a tedious detection to find out where the mistakes occurred. Therefore, it is sure that this problem caused by potential inattentive is not only leading to consuming time, but to wasting human resource.

### SUMMARY OF THE INVENTION

The objective of present invention is to provide an identification module for facilitating installation of a functional component, thereby to facilitate installation in high efficiency and yield thereof.

The identification module for facilitating installation of a functional component comprises a circuit board having a first connecting portion, a first functional component, a first primary label disposed on a surface of the first connecting portion and a first subsidiary label disposed on a surface of the first functional component, wherein the first subsidiary label and the first primary label respectively have two first identifying symbols corresponding to each other. With notified by the first identifying symbols, intuitional correlation may be obtained and correct installation between the first functional component and the first connecting portion is therefore guaranteed.

Notely, the first identifying symbol may be an arabic numeral, a letter, a character, a color block, a mark or a pattern. The first identifying symbol on the first subsidiary label and the first primary label is corresponding to each other.

Additionally, in present embodiment, the identification module may further comprises a second connecting portion formed on the circuit board; a second primary label disposed on the second connecting portion; a second functional component; and a second subsidiary label disposed on the second functional component.

The second primary label and the second subsidiary label respectively have two second identifying symbols corresponding to each other. The second identifying symbol may also be of letter, character, color block, mark or pattern, thereby the second primary label and the second subsidiary label may correspond to each other. With such, when installing the second functional component to the circuit board, users can intuitively and efficiently identify the correlation between the second functional component and the corresponding second connecting portion by indication of the second identifying symbols to efficiently and correctly complete an installation of the second functional component to the second connecting portion of the circuit board.

Furthermore, a method is further provided for facilitating installation of functional component, the method comprises: disposing a primary label on a connecting portion of a circuit board; providing a functional component; disposing a subsidiary label on the functional component, wherein the primary label and the subsidiary label respectively have two identifying symbols that corresponding to each other; installing the functional component to the connecting portion of the circuit board according to the identifying symbols of the subsidiary label and the primary label.

Moreover, the primary label and the subsidiary label may be disposed in the immovable manner or the removable manner. In detail, the primary label and the subsidiary label may be disposed immovable by printing, sculpting or other relevant means, or in removable manner by sticking, sucking, screwing, engaging or other relevant means. Furthermore, the first functional component according to the present invention is preferably an electronic component, a mechanical component, a protective component or a decorative component.

Additionally, multiple sets of the primary label and the subsidiary label may reveal an assembling sequence that users should follow when installation various functional components with different connecting portion of the circuit board. Follow the assembling sequence as showed on the primary label and the subsidiary label, users avoid the functional components being mounted in wrong order to caused damage.

Correspondingly, the method may further include installing the functional component with the connecting portion of the circuit board following the assembling sequence as showed on the primary label and the subsidiary label.

In order to make the aforementioned and other objects, features and advantages of the present invention comprehensible, a preferred embodiment accompanied with figures is described in detail below.

### BRIEF DESCRIPTION OF THE DRAWINGS

FIG. 1 is a schematic diagram showing the identification module in accordance with present invention.

### DETAILED DESCRIPTION OF THE PREFERRED EMBODIMENTS

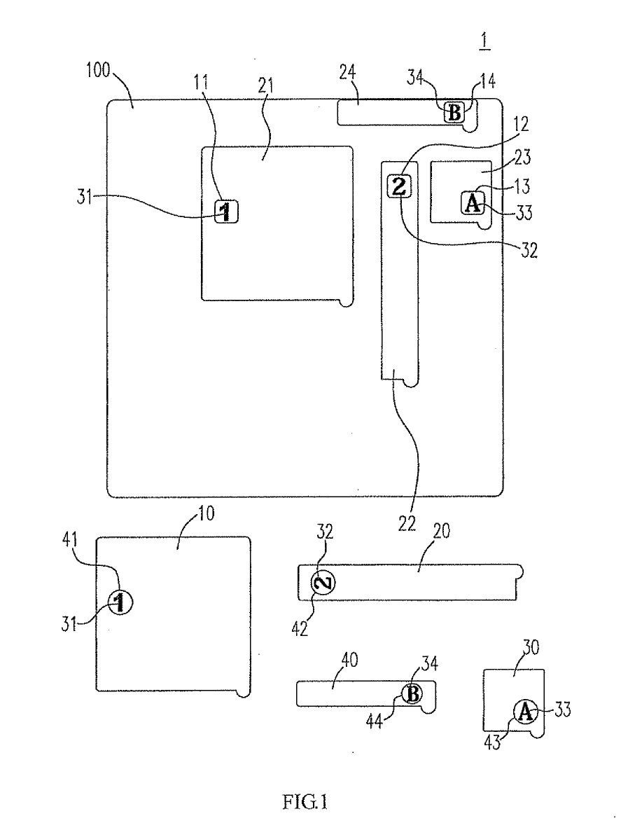

FIG. 1 is the drawing made to illustrate an embodiment of the identification module for facilitating installation of functional component in accordance with present invention. The identification module comprises: a circuit board 100 having a first connecting portion 21; a first primary label 11 disposed on a surface of the first connecting portion 21; a first functional component 10 (for example, a Central Processing Unit (CPU)); a first subsidiary label 41 disposed on the first functional component 10. The first primary label 11 and the first subsidiary label 41 respectively have two first identifying symbols 31 corresponding to each other.

In the present embodiment, the first identifying symbol 31 is an arabic numeral “1”. The first identifying symbol 31 may also be of letter, character, color block, mark or pattern, thereby the first primary label 11 and the first subsidiary label 41 generate a correlation. With such, when installing the functional components to the circuit board 100, users can intuitively and efficiently identify the indication of the first identifying symbols 31 to complete an installation of the first functional component 10 to the first connecting portion 21 of the circuit board 100. Thus, the identification module in accordance with present invention facilitates installation of functional components and increases efficiency and yield thereof.

Additionally, in the present embodiment, the identification module further comprises: a second connecting portion 22 formed on the circuit board 100; a second primary label 12 disposed on the second connecting portion 22; a second functional component 20, e.g. Dynamic Random Access Memory (DRAM); a second subsidiary label 42 disposed on the second functional component 20.

The second primary label 12 and the second subsidiary label 42 respectively have two second identifying symbols 32 corresponding to each other. In the present embodiment, the second identifying symbol 32 is an arabic numeral “2”. The second identifying symbol 32 may also be of letter, character, color block, mark or pattern, thereby the second primary label 12 and the second subsidiary label 42 corresponds to each other. With such, when installing functional components to the circuit board 100, users can intuitively and efficiently identify the indication of the second identifying symbols 32 (such as the arabic numeral “2”) to efficiently and correctly complete an installation of the second functional component 20 to the second connecting portion 22 of the circuit board 100.

The first functional component 10 and the second functional component 20 as abovementioned are preferably electronic components in the present embodiments. The first functional component 10 and the second functional component 20 may be any sort of components which mounted on the circuit board such as mechanical components, protective components or decorative components . . . etc, for increasing the efficiency of installation, reducing the mis-installed rate, and thus to save the cost while manufacturing or repairing.

Furthermore, the first identifying symbol 31 and the second identifying symbol 32 reveal an assembling sequence that users could follow when installing, e.g. the first functional component 10 with “1” is installed before the second functional component 20 with “2”. That is, the identification module for facilitating installation of functional components in accordance with the present invention further provides the instructions of installation sequence of the functional components. Such assembling sequence allows users to complete the installation in a fast and correct manner. This not only avoids component being left out during installation, but also resolve some problems caused from the functional components installed in a wrong sequence. Said problem, for example, to perform the installation in a limited space, the functional components inevitably interfered with other components that already disposed and thus are difficult to install. Even more, in some cases that the electronic devices cannot be re-booted very often for information security or system operation maintenance, some functional components would become very critically affected when installed in wrong order.

For aforesaid problems, said assembling sequence indicated from the first identifying symbol 31 and the second identifying symbol 32 can be established according to the demanded installation efficiency, so as to prevent obstacle or interference of the functional components and to provide high efficiency for installation.

With further reference to FIG. 1, the identification module for facilitating installation of functional components in accordance with present invention may further comprises: a third connecting portion 23 and a fourth connecting portion 24 mounted on the circuit board 100; a third primary label 13 and a fourth primary label 14 disposed on the third connecting portion 23 and the fourth connecting portion 24, respectively; a third functional component 30 and a fourth functional component 40; a third subsidiary label 43 disposed on the third functional component 30 and a fourth subsidiary label 44 disposed on the fourth functional component 40.

The third primary label 13 and the third subsidiary label 43 respectively have two third identifying symbols 33 that correspond to each other (both are English letter “A”), and both the fourth primary label 14 and the fourth subsidiary label 44 have two fourth identifying symbols 34 that correspond to each other (both are English letter “B”). With such, the third primary label 13 and the third subsidiary label 43 are identical, and the fourth primary label 14 and the fourth subsidiary label 44 are identical as well. When installing functional components to the circuit board 100, users can intuitively and efficiently identify the third identifying symbols 33 (the letter “A”) and the fourth identifying symbols 34 (the letter “B”) to complete the installation of the third functional component 30 and the fourth functional component 40 to the third connecting portion 23 and the fourth connecting portion 24, respectively. Thus, the identification module in accordance with present invention facilitates installation of functional components and increases efficiency and yield thereof.

According to above description, the first identifying symbol 31 and the second identifying symbol 32 is of the same type, such as arabic numerals, and the third identifying symbol 33 and the fourth identifying symbol 34 is of another type, such as English letters. In other words, the identifying symbols can be used to sort out varies components into different groups besides identification and assembling sequence indication. This enhances management of the functional components, and thereby the maintenance or inspection of the functional components may become easier.

Notely, the first primary label 11, the first subsidiary label 41, the second primary label 12, the second subsidiary label 42, the third primary label 13, the third subsidiary label 43, the fourth primary label 14 and the fourth subsidiary label 44 may selectively be implemented in immovable manner or removable manner. In detail, they may be implemented in immovable manner by printing or sculpting or other relevant means, or in removable manner by sticking, sucking, screwing or engaging or other relevant means. The sticking means include but not limit to using adhesive tape, magnets . . . etc. the sucking means include but not limit to using a sucking disk.

To conclude, the present invention provides a novel identification module for facilitating installation of functional component, which uses the same or corresponding identifying symbols on functional components and connecting portions of a circuit board for easily identification and efficient installation. Moreover, the identifying symbols revealing an assembling sequence avoids the functional components being mounted in wrong order. Besides, the identifying symbols can be grouped for enhancing management of the functional components to further facilitate maintenance or replacement of the functional components.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An identification module for facilitating installation of a functional component comprising:
a first circuit board having a first connecting portion;
a first primary label disposed on a surface of the first connecting portion;
a first functional component;
a first subsidiary label disposed on a surface of the first functional component; and
wherein the first subsidiary label and the first primary label respectively have two first identifying symbols corresponding to each other, thereby the first functional component with the first subsidiary label can be identified to install in the first connecting portion with the primary label.

2. The identification module as claimed in claim 1, wherein the first identifying symbol is an arabic numeral, a letter, a character, a color block, a mark or a pattern.

3. The identification module as claimed in claim 1, wherein the first identifying symbols of the first subsidiary label and the first primary label are identical.

4. The identification module as claimed in claim 3, wherein the first primary label and the first subsidiary label are removably disposed on the first connecting portion and the first functional component, respectively.

5. The identification module as claimed in claim 1, wherein the first primary label and the first subsidiary label are immovably disposed on the first connecting portion and the first functional component by printing or sculpting.

6. The identification module as claimed in claim 1, wherein the first functional component is an electronic component, a mechanical component, a protective component or a decorative component.

7. The identification module as claimed in claim 1, further comprises a second functional component having a second subsidiary label disposed thereon, wherein the circuit board further has a second connecting portion and a second primary label disposed on the second connecting portion, the second primary label and the second subsidiary label have two second identifying symbols corresponding to each other for the second functional component being identified and installed in the second connecting portion accordingly.

8. The identification module as claimed in claim 1, wherein the first identifying symbols and the second identifying symbols reveals an assembling sequence.
